(19) United States
(12) Patent Application Publication
(10) Pub. No.: US 2024/0202031 A1
(43) Pub. Date: Jun. 20, 2024

(54) Resource Management Method and Corresponding Apparatus

(71) Applicant: Huawei Technologies Co., Ltd., Shenzhen (CN)

(72) Inventors: Yunfeng Ye, Hangzhou (CN); Wenliang He, Hangzhou (CN)

(21) Appl. No.: 18/590,431

(22) Filed: Feb. 28, 2024

Related U.S. Application Data
(63) Continuation of application No. PCT/CN2022/114995, filed on Aug. 26, 2022.

(30) Foreign Application Priority Data
Aug. 31, 2021 (CN) 202111015561.5

(51) Int. Cl. G06F 9/50; G06F 12/1027

(52) U.S. Cl. CPC G06F 9/5016; G06F 12/1027; G06F 2212/68

(57) ABSTRACT

A resource management method applied to a computer system includes allocating first address space identifiers (ASIDs) from an ASID resource pool to processes run by a common core of the computer system; allocating a second ASID to a process of a critical service run by an isolated core of the computer system, and when the first ASIDs are exhausted, updating the first ASIDs in an ASID generation iteration manner, and refreshing a translation lookaside buffer (TLB) in the common core such that when the first ASIDs are exhausted, the second ASID allocated to the isolated core is not updated, and the TLB in the isolated core does not need to be refreshed.

### CROSS-REFERENCE TO RELATED APPLICATIONS

This is a continuation of International Patent Application No. PCT/CN2022/114995 filed on Aug. 26, 2022, which claims priority to Chinese Patent Application No. 202111015561.5 filed on Aug. 31, 2021. The disclosures of the aforementioned applications are hereby incorporated by reference in their entireties.

### TECHNICAL FIELD

This disclosure relates to the field of computer technologies, and in particular, to a resource management method and a corresponding apparatus.

### BACKGROUND

In a computer system, an address space identifier (ASID) is allocated to each newly generated process, to distinguish an independent virtual address space of each process. In addition, a translation lookaside buffer (TLB) also caches an ASID of the process and an entry of the ASID in the TLB. In this way, when the process is run subsequently, a corresponding TLB entry may be queried in the TLB based on the ASID of the process, to quickly determine a corresponding physical address based on the TLB entry. If the TLB is frequently refreshed, when the foregoing process is run again, there is a high probability that a corresponding TLB entry cannot be quickly found in the TLB, resulting in a high TLB miss, and affecting performance of the computer system.

A computer system usually runs a common service and a latency-sensitive critical service. To ensure running of the critical service, a central processing unit (CPU) of the computer system is generally divided into a non-isolated CPU core and an isolated CPU core by using an isolation technology. Non-isolated CPU cores are used to run common service processes, and isolated CPU cores are used to run critical service processes. Both common service processes and critical service processes apply for ASIDs from a global ASID resource pool. There are many common service processes, but a quantity of ASIDs in the global ASID resource pool is limited. After the ASIDs in the global ASID resource pool are exhausted by common service processes, generation iteration of the global ASID resource pool is performed. Generation iteration means that the ASID is repeatedly used by updating a generation number of the ASID, so that subsequent processes can have available ASIDs. During iteration of the global ASID resource pool, to avoid ASID conflicts of different generations after iteration, the TLB in each CPU needs to be refreshed to invalidate ASIDs of a previous generation in the TLB.

Because the global ASID resource pool is frequently iterated, the TLB in the isolated core is frequently refreshed. As a result, there is a high probability that the TLB miss occurs on the processes run by the isolated core, increasing a latency of a critical service run by the isolated CPU core.

### SUMMARY

This disclosure provides a resource management method, used to manage an ASID, to reduce a latency of a critical service run by an isolated CPU core. This disclosure further provides a corresponding apparatus, a computer device, a computer-readable storage medium, a computer program product, and the like.

A first aspect of this disclosure provides a resource management method. The method is applied to a computer system. The computer system includes a first processor core and a second processor core that is in an isolated environment. The method includes allocating first ASIDs from an ASID resource pool to processes run by the first processor core, where the ASID resource pool includes a plurality of first ASIDs, allocating a second ASID to a process run by the second processor core, and when the first ASIDs in the ASID resource pool are exhausted, updating only the first ASIDs in the ASID resource pool in an ASID generation iteration manner, invalidating the first ASIDs allocated to the processes run by the first processor core, and refreshing a TLB in the first processor core.

In this disclosure, both the first processor core and the second processor core are CPU cores. “Being in an isolated environment” may refer to software isolation. A process scheduling policy may be set by using an isolation technology, so that the first processor core runs a process of a common service when working, and the second processor core runs a process of a latency-sensitive critical service when working. There may be one or more first processor cores, and there may also be one or more second processor cores. “A plurality of” in this disclosure means two or more than two.

In this disclosure, a process run by the first processor core may be referred to as a process of a common service, and a process run by the second processor core may be referred to as a process of a critical service.

In this disclosure, the first ASID and the second ASID may be located in a global ASID resource pool, or may be located in two different ASID resource pools. The first ASID refers to an ASID allocated to a process of a common service, and the second ASID refers to an ASID allocated to a process of a critical service. There is a plurality of first ASIDs, and each first ASID is different. There may be one or more second ASIDs, and each second ASID is different. In addition, the first ASID is different from the second ASID.

In this disclosure, ASIDs in a computer system are usually a series of indexes, a quantity of ASIDs is usually limited, and processes in the computer system are infinite. Therefore, after the ASIDs in the resource pool are exhausted, generation iteration of the ASIDs needs to be performed to update the ASIDs in the resource pool. Generation iteration refers to the reuse of ASIDs in the resource pool by changing a generation identifier (GEN ID). To avoid ASID conflicts of different generations, after generation iteration occurs, the computer system invalidates an ASID that is of a previous generation and that is allocated to a process before generation iteration, and refreshes a TLB in a corresponding processor core, to avoid that a same ASID corresponds to two different TLB entries in the TLB, thereby causing a physical address access error.

In the first aspect, after the first ASIDs in the resource pool are exhausted, only the first ASIDs allocated to the processes run by the first processor core are updated, and the second ASID allocated to the process run by the second processor core is not updated, and only the TLB in the first processor core is refreshed, but the TLB in the second processor core is not refreshed. In this way, the TLB in the second processor core stores the TLB entry of the process of the critical service. When the process of the critical service needs to access a corresponding physical address, the corresponding physical address may be directly found by querying the TLB in the second processor core, and the corresponding physical address does not need to be searched for by using a page table, thereby accelerating an access speed of the physical address and reducing a latency of the critical service.

In a possible implementation of the first aspect, the foregoing step of allocating a second ASID to a process run by a second processor core includes allocating the second ASID from another ASID resource pool to the process run by the second processor core, where the another ASID resource pool includes a plurality of second ASIDs.

In this possible implementation, the computer system may include two ASID resource pools. One resource pool includes first ASIDs, to provide ASIDs for processes of common services. The other ASID resource pool includes second ASIDs. ASIDs in the two resource pools are different. For example, the computer system has 60000 ASIDs, and index sequence numbers are from 00001 to 60000. An ASID resource pool 1 may include ASIDs from 00001 to 55000, and an ASID resource pool 2 may include ASIDs from 55001 to 60000. When there are two ASID resource pools, the resource pool including the second ASIDs includes a plurality of second ASIDs. Because processes of critical services are much less than processes of common services, the second ASIDs are consumed slowly. Even if the first ASIDs are consumed quickly, because generation iteration occurs, the second ASIDs are not affected. Without generation iteration for the second ASID, the TLB in the second processor core does not need to be refreshed. In this way, the TLB in the second processor core stores TLB entries of processes of critical services. When the process of the critical service needs to access a corresponding physical address, the corresponding physical address may be directly found by querying the TLB in the second processor core, and the corresponding physical address does not need to be searched for by using a page table, thereby accelerating an access speed of the physical address and reducing a latency of the critical service.

In a possible implementation of the first aspect, the foregoing step of allocating a second ASID to a process run by a second processor core includes allocating the second ASID from the ASID resource pool to the process run by the second processor core, where the ASID resource pool includes at least one second ASID, and storing reservation information of the allocated second ASID, where the reservation information indicates that the allocated second ASID is reserved.

The foregoing step of updating the first ASIDs in the ASID resource pool in an ASID generation iteration manner includes determining the first ASIDs in the ASID resource pool based on the reservation information of the allocated second ASID, and updating the first ASIDs in the ASID generation iteration manner.

In this possible implementation, the first ASID and the second ASID are located in a same ASID resource pool, and the ASID resource pool may also be referred to as a global ASID resource pool. When ASIDs are allocated to a process run by the first processor core and a process run by the second processor core, the ASIDs are extracted from the global ASID resource pool, and reservation information is stored only for the ASID allocated to the process run by the second processor core, where the reservation information indicates that the ASID allocated to the process run by the second processor core is reserved. For example, there are 60000 ASIDs in the global ASID resource pool, and index sequence numbers are from 00001 to 60000. If 00111 is allocated to a process run by the second processor core, reservation information reserved for 00111 is stored. In this way, when the first ASIDs are updated, only the ASIDs allocated to the processes run by the first processor core may be updated from all ASIDs in the global ASID resource pool based on the reservation information, but the ASID allocated to the process run by the second processor core is not updated. In this way, the global ASIDs do not need to be divided, which is more conducive to improving utilization of the ASID.

In a possible implementation of the first aspect, the step of storing reservation information of the allocated second ASID, where the reservation information indicates that the allocated second ASID is reserved includes modifying, from an unreserved state to a reserved state in a reservation bitmap, an identifier in an identifier bit corresponding to the allocated second ASID, where the reservation bitmap is used to record a reservation status of each ASID in the ASID resource pool.

In this disclosure, the reservation information of the allocated second ASID may be stored by using the reservation bitmap. The identifier bit may be a bit, and the reservation bitmap indicates a reservation status of the ASID in a form of a bit. A quantity of bits in the reservation bitmap is equal to a quantity of ASIDs in the global ASID resource pool. For example, if the computer system has 60000 ASIDs, there are 60000 bits in the reserved bitmap. The 60000 ASIDs are in a one-to-one correspondence with the 60000 bits, and each bit corresponds to one ASID.

In this disclosure, for each bit, 0 may indicate that an ASID corresponding to the bit is not reserved, and 1 may indicate that an ASID corresponding to the bit is reserved, that is, the ASID corresponding to the bit is allocated to the process run by the second processor core. Certainly, on the contrary, 1 may indicate that an ASID corresponding to the bit is not reserved, and 0 may indicate that an ASID corresponding to the bit is reserved. Certainly, a representation form of the identifier is not limited to 0 or 1, or another identifier may indicate a reserved state or an unreserved state.

In this possible implementation, the reservation status of the second ASID allocated to the process run by the second processor core is recorded by using the reservation bitmap, so that the second ASID can be effectively prevented from being reallocated.

In a possible implementation of the first aspect, the foregoing step of determining the first ASIDs in the ASID resource pool based on the reservation information of the allocated second ASID, and updating the first ASIDs in the ASID generation iteration manner includes determining, based on a global bitmap and the reserved state that is of the allocated second ASID and that is in the reservation bitmap, the first ASIDs on which generation iteration needs to be performed, where the global bitmap is used to record allocation statuses of ASIDs in the ASID resource pool, and updating the first ASIDs in the ASID resource pool in the ASID generation iteration manner, and modifying, from an allocated state to an unallocated state, identifiers that are in the global bitmap and that indicate statuses of the first ASIDs.

In this disclosure, the global bitmap is a bitmap that identifies an allocation status of each ASID in the global ASID resource pool in a form of a bit. For each bit, 0 may indicate that an ASID corresponding to the bit is not allocated, and 1 may indicate that an ASID corresponding to the bit is allocated. Certainly, on the contrary, 1 may indicate that an ASID corresponding to the bit is not allocated, and 0 may indicate that an ASID corresponding to the bit is allocated. Certainly, a representation form of the identifier is not limited to 0 or 1, and another identifier may also indicate an allocated state or an unallocated state.

In this disclosure, after the first ASIDs in the global ASID resource pool are exhausted, all bits in the global bitmap may be 1. In this way, ASIDs corresponding to bits 1 in the reservation bitmap may be reserved by copying the reservation bitmap, and ASIDs corresponding to other bits in the global bitmap are all first ASIDs that need to be updated. When the first ASIDs are updated in the generation iteration manner, bits 1 in the global bitmap except the bits corresponding to 1 in the reservation bitmap need to be reset to 0.

In this possible implementation, the first ASIDs are updated by using the global bitmap and the reservation bitmap, so that a speed of updating the first ASIDs can be improved.

In a possible implementation of the first aspect, the method further includes, when the ASID resource pool further includes an unallocated ASID, and a quantity of second ASIDs allocated to processes run by the second processor core exceeds a waterline, allocating a second ASID from the unallocated ASID to a process run by the second processor core, and modifying, from an unreserved state to a reserved state, an identifier bit that is of the second ASID allocated to the process run by the second processor core and that is in the reservation bitmap, where the waterline indicates a maximum quantity of second ASIDs reserved for the second processor core.

In this possible implementation, the waterline refers to a maximum quantity of second ASIDs reserved for the second processor core, or the waterline may be understood as a condition for triggering refreshing of the TLB in the second processor core. Refreshing of the TLB in the second processor core is triggered only when the quantity of allocated second ASIDs exceeds the waterline and there is no ASID that can be allocated in the global ASID resource pool. Provided that ASIDs in the global ASID resource pool are not exhausted, refreshing of the TLB in the second processor core is not triggered. In this way, a quantity of times of refreshing the TLB in the second processor core can be minimized, and a latency of a critical service run by the second processor core is reduced.

In a possible implementation of the first aspect, the method further includes, when the ASID resource pool does not include an unallocated ASID, and a quantity of second ASIDs allocated to processes run by the second processor core exceeds a waterline, updating all the ASIDs in the ASID resource pool, modifying, from an allocated state to an unallocated state, identifiers that indicate statuses of all the ASIDs and that are in the global bitmap, and modifying identifiers in the reservation bitmap from a reserved state to an unreserved state, where the waterline indicates a maximum quantity of second ASIDs reserved for the second processor core.

In this possible implementation, refreshing of the TLB in the second processor core is triggered only when the quantity of allocated second ASIDs exceeds the waterline and there is no ASID that can be allocated in the global ASID resource pool. This helps reduce a quantity of times of refreshing the TLB in the second processor core, and reduce a latency of a critical service run by the second processor core.

In a possible implementation of the first aspect, the method further includes obtaining a context identifier (context ID) of the process run by the second processor core, and if the context ID of the process includes a non-isolation identifier, modifying the non-isolation identifier into an isolation identifier, and modifying, from an unreserved state to a reserved state, an identifier that is of an ASID included in the context ID and that is in the reservation bitmap.

In this possible implementation, the context ID usually includes an ASID allocated to the process and a GEN ID of the ASID. To facilitate determining, through one atomic operation, a status in which the ASID is allocated to the process, an isolation identifier and a non-isolation identifier are set in the context ID in this disclosure. The isolation identifier indicates that the ASID in the context ID is an ASID allocated to a process of a critical service run by the second processor core. The non-isolation identifier indicates that an ASID in the context ID is an ASID allocated to a process of a common service run by the first processor core. When the context ID of the process run by the second processor core includes the non-isolation identifier, it indicates that process migration may occur in the process run by the second processor core, and the process is migrated from the first processor core to the second processor core. The process may alternatively be a multi-thread process, where some threads are run by the first processor core, and some threads are run by the second processor core. In this case, to avoid impact of the updating of the first ASIDs on the process run by the second processor core, the non-isolation identifier in the process needs to be modified to the isolation identifier, and a bit that is in the reservation bitmap and that corresponds to the ASID included in the process is modified from the unreserved state to the reserved state, that is, from 0 to 1. In this way, the solution of this disclosure can be more flexibly applicable to an environment in which a process is migrated and to a scenario in which a process includes a plurality of threads and the plurality of threads run in different environments.

A second aspect of this disclosure provides a resource management apparatus. The resource management apparatus has a function of implementing the method according to any one of the first aspect or the possible implementations of the first aspect. The function may be implemented by hardware, or may be implemented by hardware executing corresponding software. The hardware or software includes one or more modules corresponding to the foregoing function, for example, a first processing unit, a second processing unit, and a third processing unit. The three processing units may be implemented by using one or more processing units.

A third aspect of this disclosure provides a computer device. The computer device includes at least one processor, a memory, an input/output (I/O) interface, and computer-executable instructions that are stored in the memory and that can run on the processor. When the computer-executable instructions are executed by the processor, the processor performs the method according to any one of the first aspect or the possible implementations of the first aspect.

A fourth aspect of this disclosure provides a computer-readable storage medium storing one or more computer-executable instructions. When the computer-executable instructions are executed by a processor, the one or more processors perform the method according to any one of the first aspect or the possible implementations of the first aspect.

A fifth aspect of this disclosure provides a computer program product storing one or more computer-executable instructions. When the computer-executable instructions are executed by a processor, the one or more processors perform the method according to any one of the first aspect or the possible implementations of the first aspect.

A sixth aspect of this disclosure provides a chip system. The chip system includes at least one processor, and the at least one processor is configured to support a resource management apparatus in implementing the function according to any one of the first aspect or the possible implementations of the first aspect. In a possible design, the chip system may further include a memory. The memory is configured to store program instructions and data that are necessary for the resource management apparatus. The chip system may include a chip, or may include a chip and another discrete component.

### BRIEF DESCRIPTION OF DRAWINGS

FIG. 1 is a schematic diagram of a structure of a computer system according to an embodiment of this disclosure;

FIG. 2 is a schematic diagram of an example according to an embodiment of this disclosure;

FIG. 3 is another schematic diagram of a structure of a computer system according to an embodiment of this disclosure;

FIG. 4 is a schematic flowchart of an embodiment of a resource management method according to an embodiment of this disclosure;

FIG. 5 is another schematic diagram of a structure of a computer system according to an embodiment of this disclosure;

FIG. 6 is another schematic diagram of a structure of a computer system according to an embodiment of this disclosure;

FIG. 7 is a schematic diagram of an example of a reservation bitmap according to an embodiment of this disclosure;

FIG. 8 is a schematic diagram of an example of a global bitmap according to an embodiment of this disclosure;

FIG. 9 is a schematic diagram of an example scenario of a resource management method according to an embodiment of this disclosure;

FIG. 10 is a schematic flowchart of another embodiment of a resource management method according to an embodiment of this disclosure;

FIG. 11 is a schematic diagram of another example scenario of a resource management method according to an embodiment of this disclosure;

FIG. 12 is a schematic diagram of an example of a context ID of a process according to an embodiment of this disclosure;

FIG. 13 is a schematic diagram of an embodiment of a resource management apparatus according to an embodiment of this disclosure; and

FIG. 14 is a schematic diagram of a structure of a computer device according to an embodiment of this disclosure.

### DESCRIPTION OF EMBODIMENTS

The following describes embodiments of this disclosure with reference to accompanying drawings. It is clear that the described embodiments are merely some but not all of embodiments of this disclosure. A person of ordinary skill in the art may learn that, with technical development and emergence of a new scenario, the technical solutions provided in embodiments of this disclosure are also applicable to a similar technical problem.

In the specification, claims, and accompanying drawings of this disclosure, the terms “first”, “second”, and the like are intended to distinguish between similar objects but do not necessarily indicate a specific order or sequence. It should be understood that the data termed in such a way is interchangeable in proper circumstances so that the embodiments of the present disclosure described herein can be implemented in orders other than the order illustrated or described herein. Moreover, the terms “include”, “contain” and any other variants mean to cover the non-exclusive inclusion, for example, a process, method, system, product, or device that includes a list of steps or units is not necessarily limited to those steps or units, but may include other steps or units not expressly listed or inherent to such a process, method, product, or device.

An embodiment of this disclosure provides a resource management method, used to manage an ASID, to reduce a latency of a critical service run by an isolated CPU core. This disclosure further provides a corresponding apparatus, a computer device, a computer-readable storage medium, a computer program product, and the like. Details are separately described in the following.

The resource management method provided in this embodiment of this disclosure is applied to a computer system. The computer system may be a server, a terminal device, a virtual machine (VM), a container, or the like.

The terminal device (or a user equipment (UE)) is a device having a wireless transceiver function, and may be deployed on land, for example, including an indoor or outdoor device, a handheld device, or a vehicle-mounted device, may be deployed on water (for example, on a ship), or may be deployed in the air (for example, on an airplane, a balloon, and a satellite). The terminal may be a mobile phone, a tablet computer (or IPAD), a computer having a wireless transceiver function, a virtual reality (VR) terminal, an augmented reality (AR) terminal, a wireless terminal in industrial control, a wireless terminal in self driving, a wireless terminal in remote medical, a wireless terminal in a smart grid, a wireless terminal in transportation safety, a wireless terminal in a smart city, a wireless terminal in a smart home, or the like.

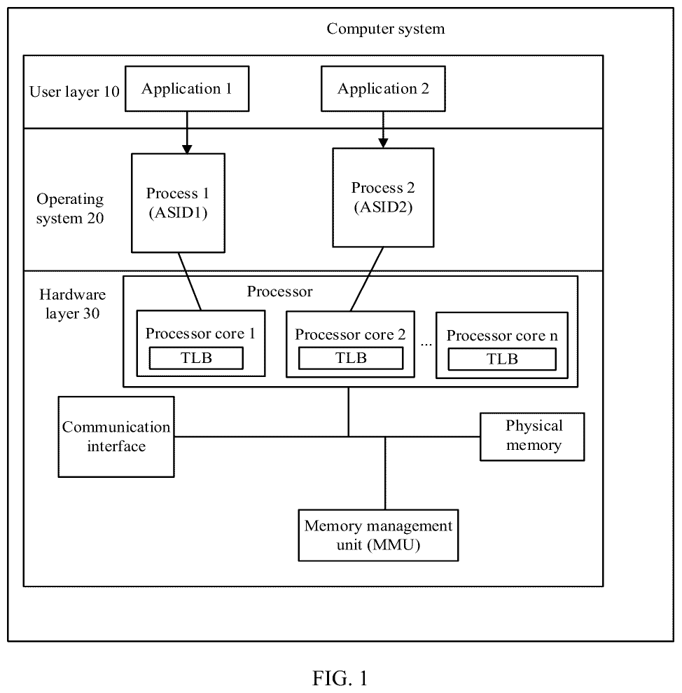

The structure of the computer system may be understood with reference to FIG. 1. FIG. 1 is a schematic diagram of a structure of a computer system.

As shown in FIG. 1, the structure of the computer system includes a user layer 10, an operating system 20, and a hardware layer 30.

The user layer 10 includes a plurality of applications (APP), and each application may correspond to one process when running. For example, a process of an application 1 is a process 1 when the application 1 is running, and a process of an application 2 is a process 2 when the application 2 is running.

The operating system (OS) 20 is used to run a process of each application, for example, the process 1 and the process 2.

The hardware layer 30 includes a communication interface, a processor, a physical memory, a memory management unit (MMU), a bus, and the like. The communication interface, the processor, the physical memory, and the MMU are connected through the bus. The processor may include a CPU or any type of general-purpose computing circuit or dedicated logic circuit, for example, a field-programmable gate array (FPGA) or an application-specific integrated circuit (ASIC). The processor may alternatively be one or more processors coupled to one or more semiconductor substrates, such as a CPU. The physical memory may be configured as multiple memory spaces. The MMU is computer hardware responsible for processing a memory access request from the CPU. A function of the MMU includes translation from a virtual address to a physical address, memory protection, and CPU cache control.

There may be a plurality of CPUs, and each CPU may also have a plurality of “cores”. The core is referred to as a processor core in this embodiment of this disclosure. As shown in FIG. 1, the processor includes a processor core 1, a processor core 2, . . . , and a processor core n, where n is an integer greater than 2. Certainly, FIG. 1 shows a scenario in which there are at least three processor cores. In an embodiment, the computer system may alternatively include two processor cores. Each processor core includes a TLB. In a running process of a process, to access data on a physical page, a corresponding physical address usually needs to be searched for based on a virtual address and an entry, to access the data on the corresponding physical page. The entry records a mapping relationship between the virtual address and the corresponding physical address. The entry exists in a page table. However, if an entry is recently used, the entry is also cached in a TLB in a corresponding processor core. The entry cached in the TLB may be referred to as a TLB entry. In this way, when the processor core runs the process to use the entry again, the processor core may obtain the entry from the TLB in the processor core, to quickly access a corresponding physical page.

One process may be run by each processor core at a time point. For example, the processor core 1 runs the process 1, and the processor core 2 runs the process 2. Certainly, at different time points, the process 1 and the process 2 may also be run by another processor core. A processor core occupied by a process during running may be scheduled and configured at a software layer.

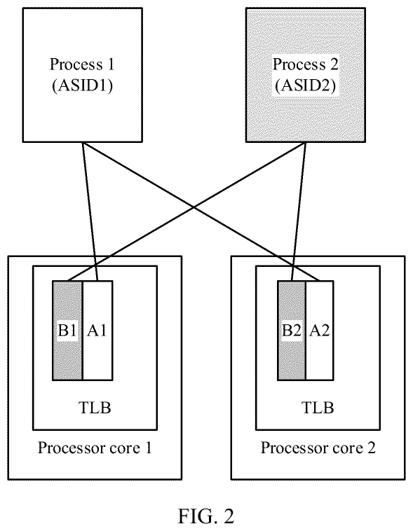

When each process runs for the first time, the operating system allocates an ASID to the process. For example, an ASID1 is allocated to the process 1 when the process runs for the first time, and an ASID2 is allocated to the process 2 when the process runs for the first time. A TLB in a processor core that runs the process caches an ASID allocated to the process. In the TLB, the ASID of the process is associated with a TLB entry used by the process for caching. As shown in FIG. 2, when the process 1 is run by a processor core 1, the TLB in the processor core 1 caches a correspondence between the ASID1 of the process 1 and a TLB entry, as shown by a strip A1 in the TLB. When the process 1 is run by the processor core 2, the TLB in the processor core 2 caches a correspondence between the ASID1 of the process 1 and a TLB entry, as shown by a strip A2 in the TLB. Similarly, when the process 2 is run by the processor core 1, the TLB in the processor core 1 caches a correspondence between the ASID2 of the process 1 and a TLB entry, as shown by a strip B1 in the TLB. When the process 2 is run by the processor core 2, the TLB in the processor core 2 caches a correspondence between the ASID2 of the process 2 and a TLB entry, as shown by a strip B2 in the TLB. In this way, when the processor core runs the process next time, the corresponding TLB entry may be found based on the ASID of the process, to implement fast translation from a virtual address to a physical address, thereby quickly accessing a corresponding physical page.

With development of technologies, some service scenarios are sensitive to a latency. For example, a fifth generation (5G) scenario and an edge computing scenario have a high requirement on a latency. To ensure running of these latency-sensitive services, an isolation technology may be used to divide a processor core of a processor into a common core and an isolated core, and the isolated core runs in an isolated environment. In this embodiment of this disclosure, the “isolated environment” may refer to software isolation. A process scheduling policy may be set by using an isolation technology, so that a latency-sensitive service is run by an isolated core, and a latency-insensitive service is run by a common core. In this embodiment of this disclosure, a process run by a common core may be referred to as a process of a common service, and a process run by an isolated core may be referred to as a process of a critical service.

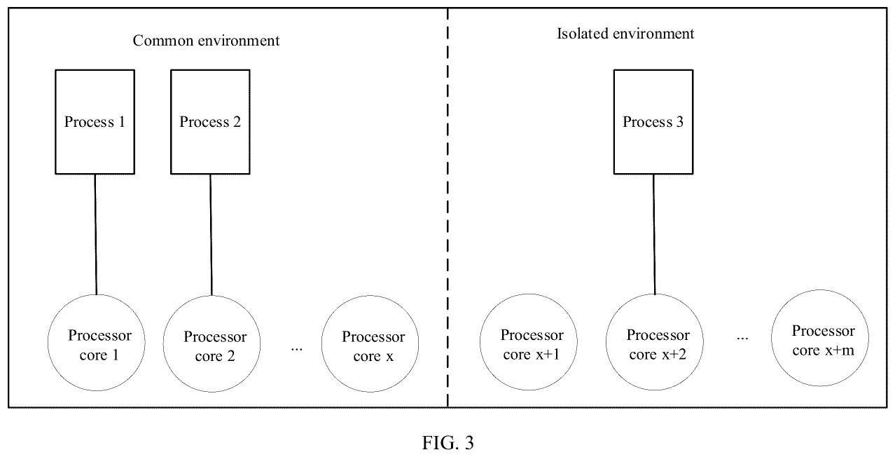

As shown in FIG. 3, processor cores in a computer system are recorded as two types through software configuration. One is a common core, for example, a processor core 1, a processor core 2, . . . , and a processor core x, and the other is an isolated core, for example, a processor core (x+1), a processor core (x+2), . . . , and a processor core (x+m). It may also be understood that the common core runs in a common environment, and the isolated core runs in an isolated environment. The common environment and the isolated environment are not limited to physical isolation on hardware. Different types of processes may be scheduled to different processor cores through software configuration. For example, a latency-sensitive process 3 is scheduled to the processor core x+2 for running, a latency-insensitive process 1 is scheduled to the processor core 1 for running, and a latency-insensitive process 2 is scheduled to the processor core 2 for running.

Even if the processor core is recorded as two types: a common core and an isolated core, a manner in which the operating system allocates an ASID to the process remains unchanged, that is, an ASID is applied for from an ASID resource pool, and a unique ASID is allocated to the process when the process runs for the first time, until the ASID of the process is invalidated. ASIDs are usually a series of indexes, a quantity of ASIDs is usually limited, and processes in the computer system are infinite. Therefore, after the ASIDs in the ASID resource pool are exhausted, generation iteration of the ASIDs needs to be performed to update the ASIDs in the resource pool. Generation iteration refers to the reuse of ASIDs in the resource pool by changing a GEN ID. To avoid ASID conflicts of different generations, after generation iteration occurs, the computer system invalidates an ASID that is of a previous generation and that is allocated to a process before generation iteration, and refreshes a TLB in a corresponding processor core, to avoid that a same ASID corresponds to two different TLB entries in the TLB, thereby causing a physical address access error.

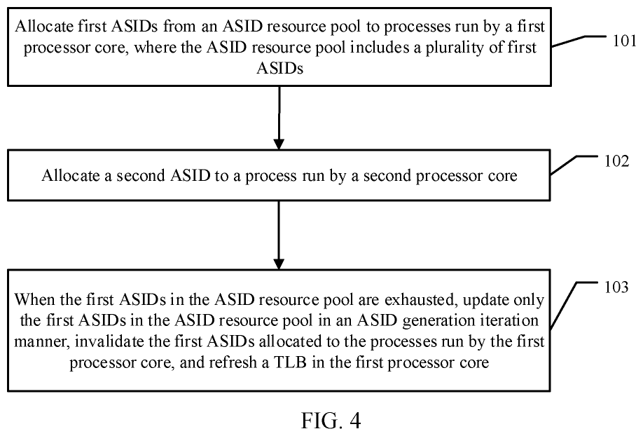

Because a quantity of processes of common services is large, the processes of the common services occupy a large quantity of ASIDs. If the ASIDs are exhausted, generation iteration of the ASIDs needs to be performed. In this case, TLBs in the common core and the isolated core need to be refreshed, which causes a latency jitter of a critical service. To avoid and reduce the latency jitter of the critical service, the foregoing computer system is based on, and the computer system includes a first processor core and a second processor core that is in an isolated environment. This embodiment of this disclosure provides a resource management method. As shown in FIG. 4, an embodiment of the resource management method includes the following steps.

Step 101: Allocate first ASIDs from an ASID resource pool to processes run by the first processor core, where the ASID resource pool includes a plurality of first ASIDs.

In this embodiment of this disclosure, both the first processor core and the second processor core are CPU cores. There may be one or more first processor cores, and there may also be one or more second processor cores. “A plurality of” in this disclosure means two or more than two. For example, the first processor core may be the processor core 1, the processor core 2, . . . , and the processor core x in FIG. 3, and the second processor core may be a processor core (x+1), a processor core (x+2), . . . , and a processor core (x+m) in FIG. 3.

Step 102: Allocate a second ASID to a process run by a second processor core.

The first ASID refers to an ASID allocated to a process of a common service, and the second ASID refers to an ASID allocated to a process of a critical service. There is a plurality of first ASIDs, and each first ASID is different. There may be one or more second ASIDs, and each second ASID is different. In addition, the first ASID is different from the second ASID.

Step 103: When the first ASIDs in the ASID resource pool are exhausted, update only the first ASIDs in the ASID resource pool in an ASID generation iteration manner, invalidate the first ASIDs allocated to the processes run by the first processor core, and refresh a TLB in the first processor core.

In this embodiment of this disclosure, after the first ASIDs in the resource pool are exhausted, only the first ASIDs allocated to the processes run by the first processor core are updated, and the second ASID allocated to the process run by the second processor core is not updated, and only the TLB in the first processor core is refreshed, but the TLB in the second processor core is not refreshed. In this way, the TLB in the second processor core stores the TLB entry of the process of the critical service. When the process of the critical service needs to access a corresponding physical address, the corresponding physical address may be directly found by querying the TLB in the second processor core, and the corresponding physical address does not need to be searched for by using a page table, thereby accelerating an access speed of the physical address and reducing a latency of the critical service.

Optionally, in the resource management solution provided in this embodiment of this disclosure, the first ASID and the second ASID may be located in a same global ASID resource pool, or may be located in two different ASID resource pools. The following provides specific descriptions.
I. The first ASID and the second ASID are located in two different ASID resource pools.

The computer system may maintain two ASID resource pools. One resource pool includes first ASIDs, to provide ASIDs for processes of common services. The other ASID resource pool includes second ASIDs, to provide ASIDs for processes of critical services. ASIDs in the two resource pools are different. When there are two ASID resource pools, the resource pool including the second ASIDs includes a plurality of second ASIDs.

In this way, the foregoing step 102 includes allocating the second ASID from another ASID resource pool to the process run by the second processor core, where the another ASID resource pool includes a plurality of second ASIDs.

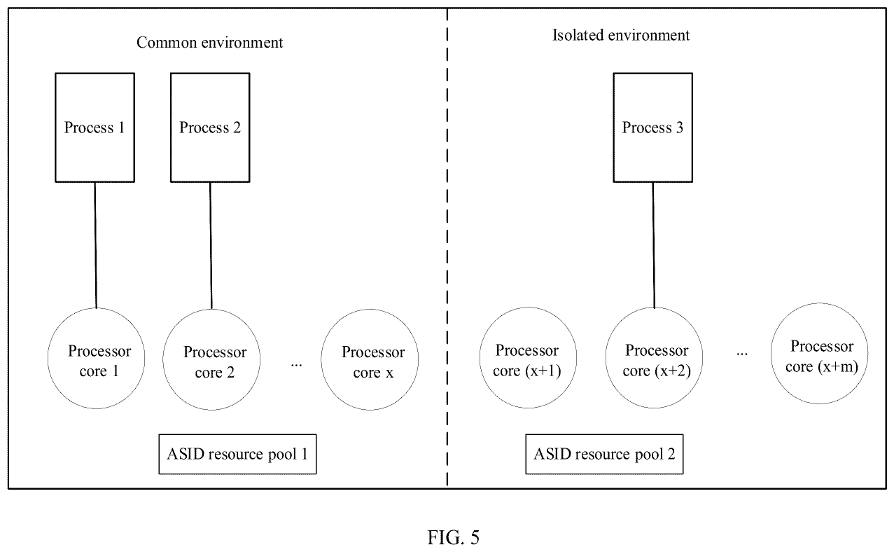

As shown in FIG. 5, the computer system maintains an ASID resource pool 1 for a common environment, and maintains an ASID resource pool 2 for an isolated environment. In this way, when an ASID is allocated to a process run by any processor core of the processor core 1, the processor core 2, . . . , and the processor core x, the ASID may be applied for from the ASID resource pool 1, and when an ASID is allocated to a process run by any processor core of the processor core (x+1), the processor core (x+2), . . . , and the processor core (x+m), the ASID may be applied for from the ASID resource pool 2.

ASIDs in the ASID resource pool 1 and in the ASID resource pool 2 are different. For example, the computer system has 60000 ASIDs, and index sequence numbers are from 00001 to 60000. An ASID resource pool 1 may include ASIDs from 00001 to 55000, and an ASID resource pool 2 may include ASIDs from 55001 to 60000. Certainly, allocation of the ASIDs in the two resource pools is merely an example herein, and a specific division manner may be set based on a requirement.

Generally, because processes of critical services created by a computer system are much less than processes of common services, the second ASIDs are consumed slowly. Even if the first ASIDs are consumed quickly, because generation iteration occurs, the second ASIDs are not affected. Without generation iteration for the second ASID, the TLB in the second processor core does not need to be refreshed. In this way, the TLB in the second processor core stores TLB entries of processes of critical services. When the process of the critical service needs to access a corresponding physical address, the corresponding physical address may be directly found by querying the TLB in the second processor core, and the corresponding physical address does not need to be searched for by using a page table, thereby accelerating an access speed of the physical address and reducing a latency of the critical service.
II. The first ASID and the second ASID are located in a same global ASID resource pool.

When there is only one global ASID resource pool in the computer system, the foregoing step 102 includes allocating the second ASID from the ASID resource pool to the process run by the second processor core, where the ASID resource pool includes at least one second ASID, and storing reservation information of the allocated second ASID, where the reservation information indicates that the allocated second ASID is reserved.

The foregoing step 103 includes determining the first ASIDs in the ASID resource pool based on the reservation information of the allocated second ASID, and updating the first ASIDs in the ASID generation iteration manner.

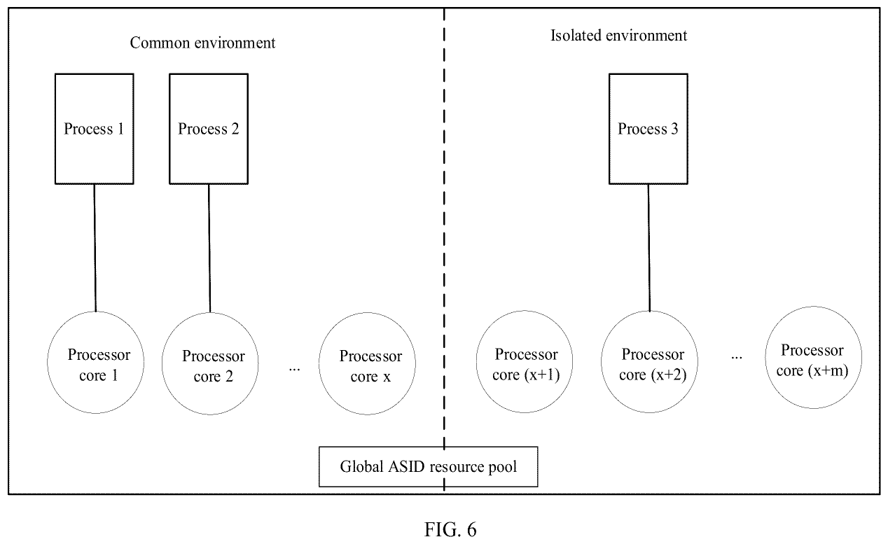

As shown in FIG. 6, the computer system maintains only one global ASID resource pool for a common environment and an isolated environment. In this way, when an ASID is allocated to a process run by any processor core of the processor core 1, the processor core 2, . . . , and the processor core x, the ASID needs to be applied for from the global ASID resource pool, and when an ASID is allocated to a process run by any processor core of the processor core (x+1), the processor core (x+2), . . . , and the processor core (x+m), the ASID also needs to be applied for from the global ASID resource pool. For example, there are 60000 ASIDs in the global ASID resource pool, and the index sequence numbers are from 00001 to 60000. The ASIDs allocated to the processes of the common services and the ASID allocated to the process of the critical service may be allocated according to an application sequence. For example, if a computer system first runs 100 processes of the common services, and then a process of the critical service applies for an ASID, 00001 to 00100 are allocated to the first 100 processes of the common services, and 00101 is allocated to the process of the critical service. In the middle, nine processes of common services apply for 00102 to 00110, and another process of a critical service applies for 00111. In this example, 00001 to 00100 and 00102 to 00110 are all first ASIDs, and 00101 and 00111 are second ASIDs. Reservation information of the second ASID needs to be stored, and the computer system stores reservation information that is reserved for 00101 and 00111. In this way, when the ASIDs in the global ASID resource pool are exhausted and are updated in a generation iteration manner, which ASID belongs to the second ASID may be determined based on the stored reservation information, to determine other first ASIDs, and to update the first ASIDs instead of updating the second ASID. For example, after the 60000 ASIDs are exhausted, it is determined, based on the reservation information, that 00101 and 00111 are reserved, and it may be determined that iterative update needs to be performed from 00001 to 00100, 00102 to 00110, and 00112 to 60000. In this case, 00001 to 00100, 00102 to 00110, and 00112 to 60000 are updated, 00101 and 00111 do not need to be updated, and a TLB in a processor core in an isolated environment does not need to be updated, thereby avoiding a latency jitter of a critical service.

Such a manner in which the computer system maintains only one global ASID resource pool to manage the ASIDs is more conducive to improving utilization of the ASID.

In this embodiment of this disclosure, the reservation information may be stored by using a reservation bitmap. The reservation bitmap indicates a reservation status of the ASID in a form of bits. A quantity of bits in the reservation bitmap is equal to a quantity of ASIDs in the global ASID resource pool. Each bit in the reservation bitmap indicates an identifier bit of an ASID, and the identifier bit may indicate a reservation status of the ASID by using an identifier. For example, for each bit, 0 may indicate that an ASID corresponding to the bit is not reserved, and 1 may indicate that an ASID corresponding to the bit is reserved. Certainly, on the contrary, 1 may indicate that an ASID corresponding to the bit is not reserved, and 0 may indicate that an ASID corresponding to the bit is reserved. Certainly, a representation form of the identifier is not limited to 0 or 1, or another identifier may indicate a reserved state or an unreserved state. For example, if the computer system has 60000 ASIDs, there are 60000 bits in the reserved bitmap. The 60000 ASIDs are in a one-to-one correspondence with the 60000 bits, and each bit corresponds to one ASID.

Optionally, in this embodiment of this disclosure, storing reservation information of the allocated second ASID by using a reservation bitmap may be modifying, from an unreserved state to a reserved state in a reservation bitmap, an identifier in an identifier bit corresponding to the allocated second ASID, where the reservation bitmap is used to record a reservation status of each ASID in the ASID resource pool.

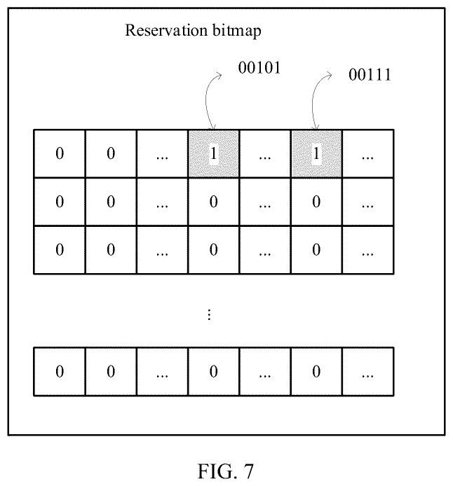

For example, if 00101 and 00111 are reserved, identifiers of bits corresponding to 00101 and 00111 in the reservation bitmap are modified from 0 to 1. As shown in FIG. 7, a bit identifier corresponding to 00101 is modified to 1, a bit identifier corresponding to 00111 is modified to 1, and identifiers of other bits are all 0.

After the reservation bitmap is used, determining the first ASIDs in the ASID resource pool based on the reservation information of the allocated second ASID, and updating the first ASIDs in the ASID generation iteration manner may include determining, based on a global bitmap and the reserved state that is of the allocated second ASID and that is in the reservation bitmap, the first ASIDs on which generation iteration needs to be performed, where the global bitmap is used to record allocation statuses of ASIDs in the ASID resource pool, and updating the first ASIDs in the ASID resource pool in the ASID generation iteration manner, and modifying, from an allocated state to an unallocated state, identifiers that are in the global bitmap and that indicate statuses of the first ASIDs.

In this embodiment of this disclosure, the global bitmap is a bitmap that identifies an allocation status of each ASID in the global ASID resource pool in a form of a bit. For each bit, 0 may indicate that an ASID corresponding to the bit is not allocated, and 1 may indicate that an ASID corresponding to the bit is allocated. Certainly, on the contrary, 1 may indicate that an ASID corresponding to the bit is not allocated, and 0 may indicate that an ASID corresponding to the bit is allocated. Certainly, a representation form of the identifier is not limited to 0 or 1, and another identifier may also indicate an allocated state or an unallocated state.

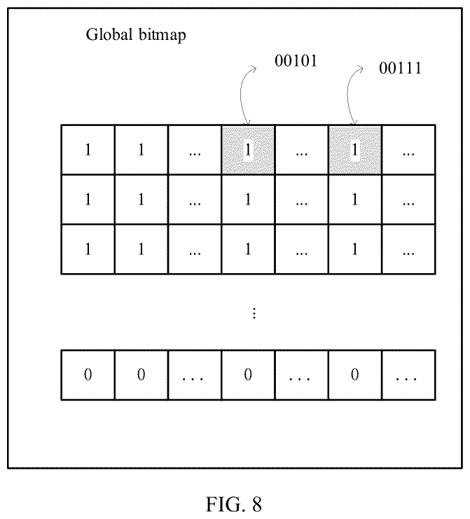

For example, if the computer system has 60000 ASIDs, there are 60000 bits in the global bitmap. The 60000 ASIDs are in a one-to-one correspondence with the 60000 bits, and each bit corresponds to one ASID. As shown in FIG. 8, in the global bitmap, regardless of whether the ASID is allocated to a process of a common service or a process of a critical service, if the ASID is allocated, a bit corresponding to the ASID in the global bitmap is modified from 0 to 1.

In this way, after the first ASIDs in the global ASID resource pool are exhausted, all bits in the global bitmap may be 1. In this way, ASIDs corresponding to bits 1 in the reservation bitmap may be reserved by copying the reservation bitmap, and ASIDs corresponding to other bits in the global bitmap are all first ASIDs that need to be updated. When the first ASIDs are updated in the generation iteration manner, bits 1 in the global bitmap except the bits corresponding to 1 in the reservation bitmap need to be reset to 0.

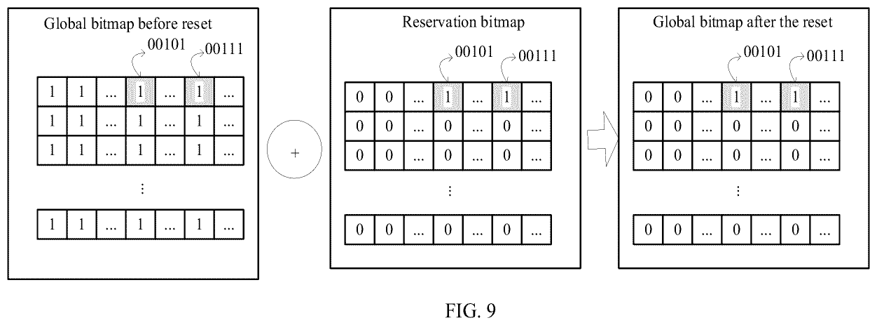

A process of updating the first ASIDs based on the reservation bitmap and the global bitmap may be understood with reference to FIG. 9. As shown in FIG. 9, if an identifier of each bit in the global bitmap before the reset is 1, it indicates that ASIDs in the global ASID resource pool are exhausted, and the ASIDs need to be updated. In this case, it needs to be determined, with reference to the reservation bitmap, that reserved ASIDs are 00101 and 00111, and then it is determined that generation iteration needs to be performed on ASIDs corresponding to other bits, and a bit of an ASID on which iteration is performed in the global bitmap needs to be reset, where 1 is reset to 0. In this way, the global bitmap after the reset in FIG. 9 is obtained.

In this embodiment of this disclosure, the reservation status of the second ASID allocated to the process run by the second processor core is recorded by using the reservation bitmap, so that the second ASID can be effectively prevented from being reallocated.

In this embodiment of this disclosure, to control a quantity of ASIDs used for the isolated core, a waterline is further set. The waterline indicates a maximum quantity of second ASIDs reserved for the second processor core. In this embodiment of this disclosure, a quantity of times of flushing the TLB in the isolated core can be further reduced through waterline control.

In this embodiment of this disclosure, whether to iteratively update the second ASID is considered only after the quantity of allocated second ASIDs exceeds the waterline. The allocated second ASID is updated with iterative update of the global ASIDs only after the first ASIDs are also exhausted.

That is, when the ASID resource pool further includes an unallocated ASID, and a quantity of second ASIDs allocated to processes run by the second processor core exceeds a waterline, a second ASID is allocated from the unallocated ASID to a process run by the second processor core, and an identifier bit that is of the second ASID allocated to the process run by the second processor core and that is in the reservation bitmap is modified from an unreserved state to a reserved state, where the waterline indicates a maximum quantity of second ASIDs reserved for the second processor core.

Alternatively, when the ASID resource pool does not include an unallocated ASID, and a quantity of second ASIDs allocated to processes run by the second processor core exceeds a waterline, all the ASIDs in the ASID resource pool are updated, identifiers that indicate statuses of all the ASIDs and that are in the global bitmap are modified from an allocated state to an unallocated state, and identifiers in the reservation bitmap are modified from a reserved state to an unreserved state, where the waterline indicates a maximum quantity of second ASIDs reserved for the second processor core.

In this embodiment of this disclosure, the waterline may be understood as a condition for triggering refreshing of the TLB in the second processor core. Refreshing of the TLB in the second processor core is triggered only when the quantity of allocated second ASIDs exceeds the waterline and there is no ASID that can be allocated in the global ASID resource pool. Provided that ASIDs in the global ASID resource pool are not exhausted, refreshing of the TLB in the second processor core is not triggered. In this way, a quantity of times of refreshing the TLB in the second processor core can be minimized, and a latency of a critical service run by the second processor core is reduced.

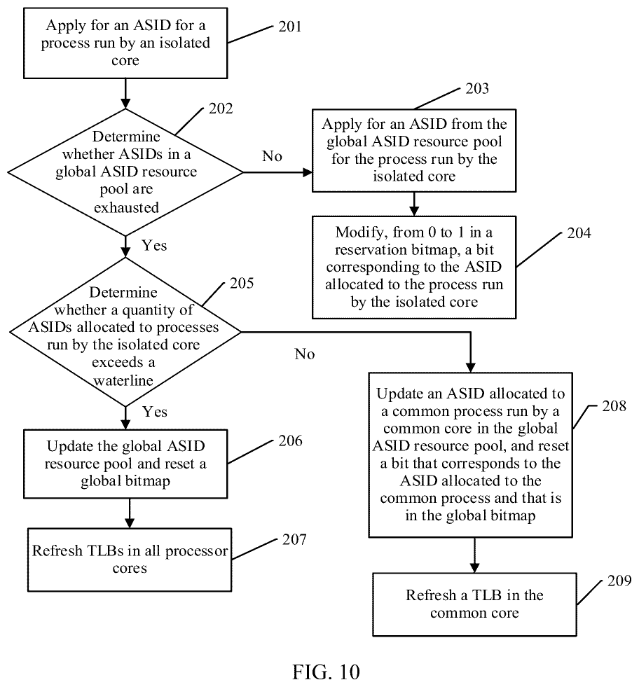

The foregoing process may be understood with reference to FIG. 10. As shown in FIG. 10, another embodiment of resource management according to an embodiment of this disclosure includes the following steps.
Step 201: Apply for an ASID from a global ASID resource pool for a process run by an isolated core.
Step 202: Determine whether ASIDs in the global ASID resource pool are exhausted, and if the ASIDs are exhausted, perform step 205, or if the ASIDs are not exhausted, perform steps 203 and 204.
Step 203: Apply for an ASID from the global ASID resource pool for the process run by the isolated core.
Step 204: Modify, from 0 to 1 in a reservation bitmap, a bit corresponding to the ASID allocated to the process run by the isolated core.
Step 205: Determine whether a quantity of ASIDs allocated to processes run by the isolated core exceeds a waterline, and if the quantity exceeds the waterline, perform steps 206 and 207, or if the quantity does not exceed the waterline, perform steps 208 and 209.
Step 206: If the quantity of ASIDs allocated to the processes run by the isolated core exceeds the waterline, update the global ASID resource pool and reset a global bitmap.
Step 207: Refresh TLBs in all processor cores.
Step 208: If the quantity of ASIDs allocated to the processes run by the isolated core does not exceed the waterline, update an ASID allocated to a common process run by a common core in the global ASID resource pool, and reset a bit that corresponds to the ASID allocated to the common process and that is in the global bitmap, that is, modify the bit from 1 to 0.
Step 209: Refresh a TLB in the common core.

In this embodiment of this disclosure, refreshing of the TLB in the isolated core is triggered only when the quantity of ASIDs allocated to the isolated core exceeds the waterline and there is no ASID that can be allocated in the global ASID resource pool. This helps reduce a quantity of times of refreshing the TLB in the isolated core, and reduce a latency of a critical service run by the isolated core.

In this embodiment of this disclosure, ASIDs are managed by using a global ASID resource pool. In this way, an ASID allocated to a process run by a first processor core and an ASID allocated to a process run by a second processor core do not need to be forcibly divided. This helps improve ASID utilization. In addition, this is applicable to process migration scenarios and a scenario in which a plurality of threads of a process run in different environments. The process migration scenarios include a scenario in which a process is migrated from a common core to an isolated core and a scenario in which a process is migrated from an isolated core to a common core. The following describes these scenarios in detail.

### I. Process Migration Scenarios.

1. A Scenario in which a Process is Migrated from a Common Core to an Isolated Core.

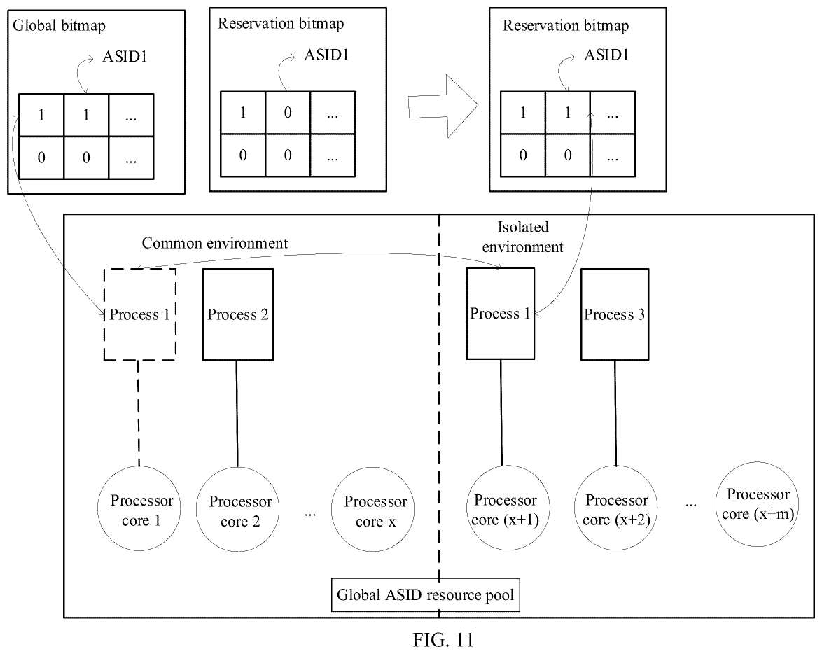

As shown in FIG. 11, a process 1 is originally run by a processor core 1 in a common environment. When the process 1 is run for the first time, an ASID allocated by a computer system to the process 1 is an ASID1, and a bit corresponding to the ASID1 is modified from 0 to 1 in a global bitmap. Because the process 1 is a process run by the processor core 1, namely, a process run by the common core, a bit corresponding to the ASID1 does not change in a reservation bitmap, a bit identifier is still 0. In this case, a context ID of the process 1 may include a GEN ID of the ASID1 and the ASID1. In this embodiment of this disclosure, an isolation identifier or a non-isolation identifier may be set in one or more bits in the GEN ID. The isolation identifier indicates that the ASID1 belongs to an isolation group, that is, the second ASID, and the non-isolation identifier indicates that the ASID1 belongs to a non-isolation group, that is, the first ASID.

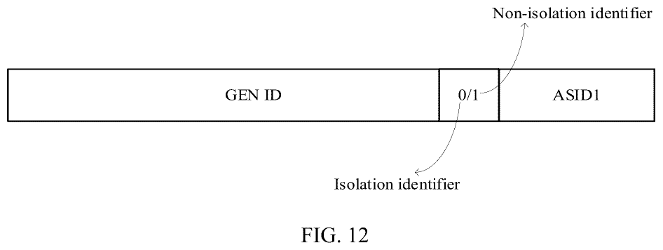

The context ID of the process 1 may be understood with reference to FIG. 12. As shown in FIG. 12, an isolation identifier or a non-isolation identifier is set in one or more bits in 48 bits. For example, the isolation identifier or the non-isolation identifier is set in one bit. If the bit is 0, it indicates that the ASID1 belongs to the isolation group. If the bit is 1, it indicates that the ASID1 belongs to the non-isolation group. Certainly, on the contrary, if the bit is 1, it indicates that the ASID1 belongs to an isolation group, or if the bit is 0, it indicates that the ASID1 belongs to a non-isolation group. In this embodiment of this disclosure, because the process 1 is run by the processor core 1 for the first time, a non-isolation identifier is set in the context ID of the process 1. For example, 1 indicates that the ASID1 belongs to the non-isolation group.

When the process 1 is migrated from the processor core 1 in the common environment to a processor core (x+1) in an isolated environment for running, the context ID of the process 1 may be obtained, that is, the GEN ID of the ASID1, the ASID1, and that the ASID1 belongs to a non-isolation group may be obtained. After the process is run by the processor core (x+1) in the isolated environment, if the ASID1 is not reserved, the ASID1 is updated with the update of first ASIDs. In this way, a latency of a critical service in the isolated environment is affected. Therefore, when it is determined that the context ID of the process 1 includes the non-isolation identifier, the non-isolation identifier is modified to an isolation identifier, the identifier of the ASID1 included in the context ID in the reservation bitmap is modified from an unreserved state to a reserved state. As shown in FIG. 11, the bit corresponding to the ASID1 in the reservation bitmap is modified from 0 to 1 after migration of the process 1.

2. A Scenario in which a Process is Migrated from an Isolated Core to a Common Core.

A process 3 in FIG. 11 is used as an example. The process 3 is originally run by a processor core (x+2) in an isolated environment. When the process 3 is run for the first time, an ASID allocated by a computer system to the process 3 is an ASID2, and a bit corresponding to the ASID2 is modified from 0 to 1 in a global bitmap, and a bit corresponding to the ASID2 is modified from 0 to 1 in a reservation bitmap. If the process 3 is migrated from the isolated environment to the common environment scenario, even if the bit in the reservation bitmap is not modified from 1 to 0, a TLB in the isolated core is not affected. Therefore, the bit of the ASID2 in the reservation bitmap may not be processed.
II. A scenario in which a plurality of threads of a process run in different environments.

An ASID allocated when a process is run for the first time is a first ASID, namely, an ASID of a process of a common service. Regardless of a quantity of threads in a process, an ASID of each thread is the same, and is an ASID allocated to the process. In this case, a context of the process includes a non-isolation identifier. After a process is run for a period of time, a plurality of threads may run. Some threads still run in a common environment, and some threads run in an isolated environment. In this case, a context of a thread run by a processor core in the isolated environment includes the non-isolation identifier. To prevent the update of first ASIDs in a global ASID resource pool from affecting a TLB in an isolated core, the foregoing process migration solution may be used to manage the ASID of the multi-thread process.

It can be learned from the foregoing description that the resource management solution provided in this embodiment of this disclosure can be more flexibly applicable to various dynamic change scenarios.

In addition, the isolation identifier or the non-isolation identifier in the context ID of the process is determined, so that ASID management in a process migration scenario, in a scenario in which a process runs across environments, and in a scenario in which a process includes a plurality of threads may be completed through one atomic operation. A lock for managing an ASID resource pool does not need to be used for a plurality of times, thereby improving performance of a computer system.

In a research and development process, an engineer of this disclosure applies the solution of this disclosure to a physical machine and a virtual machine, and tests a latency in this disclosure and a latency in a conventional technology (a global update is performed in an ASID resource pool each time, and TLBs in all processor cores are refreshed) by using a test suite (cyclictest) for testing a latency jitter, to obtain data shown in Table 1.

TABLE 1
Experiment data

| | Latency used on a | Latency used on a |
|---|---|---|
| | physical machine | virtual machine |
| Conventional technology | 18 microseconds (μs) | 360 microseconds |
| Solution of this disclosure | 4 microseconds | 90 microseconds |

It can be learned from Table 1 that, in comparison with a solution in the conventional technology, in the resource management solution provided in this embodiment of this disclosure, a latency jitter on both a physical machine and a virtual machine is greatly reduced.

The foregoing describes the resource management method. The following describes a resource management apparatus provided in embodiments of this disclosure with reference to the accompanying drawings.

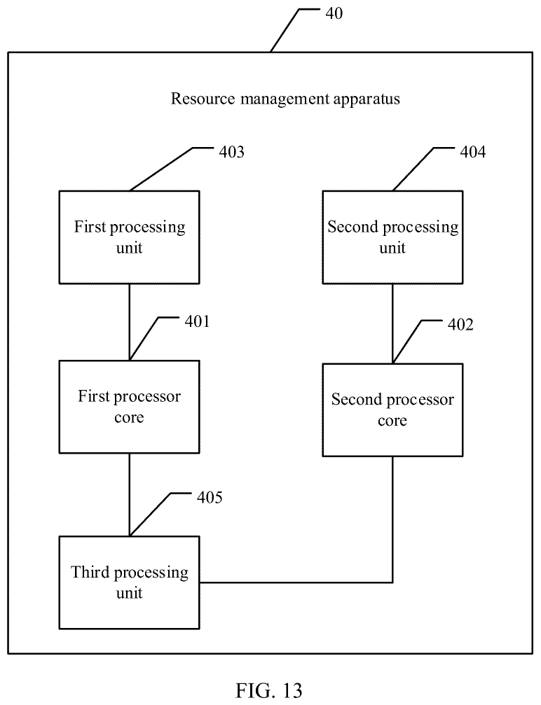

As shown in FIG. 13, an embodiment of a resource management apparatus 40 provided in this embodiment of this disclosure includes a first processor core 401, a second processor core 402 that is in an isolated environment, a first processing unit 403, a second processing unit 404, and a third processing unit 405.

The first processing unit 403 is configured to allocate first ASIDs from an ASID resource pool to processes run by the first processor core 401, where the ASID resource pool includes a plurality of first ASIDs. The first processing unit 403 is configured to perform step 101 in the foregoing method embodiment.

The second processing unit 404 is configured to allocate a second ASID to a process run by the second processor core 402. The second processing unit 404 is configured to perform step 102 in the foregoing method embodiment.

The third processing unit 405 is configured to, when the first ASIDs in the ASID resource pool are exhausted, update only the first ASIDs in the ASID resource pool in an ASID generation iteration manner, invalidate the first ASIDs allocated to the processes run by the first processor core 401, and refresh a TLB in the first processor core 401.

In this embodiment of this disclosure, after the first ASIDs in the resource pool are exhausted, only the first ASIDs allocated to the processes run by the first processor core are updated, and the second ASID allocated to the process run by the second processor core is not updated, and only the TLB in the first processor core is refreshed, but a TLB in the second processor core is not refreshed. In this way, the TLB in the second processor core stores a TLB entry of the process of the critical service. When the process of the critical service needs to access a corresponding physical address, the corresponding physical address may be directly found by querying the TLB in the second processor core, and the corresponding physical address does not need to be searched for by using a page table, thereby accelerating an access speed of the physical address and reducing a latency of the critical service.

Optionally, the second processing unit 404 is configured to allocate the second ASID from another ASID resource pool to the process run by the second processor core, where the another ASID resource pool includes a plurality of second ASIDs.

Optionally, the second processing unit 404 is configured to allocate the second ASID from the ASID resource pool to the process run by the second processor core, where the ASID resource pool includes at least one second ASID, and store reservation information of the allocated second ASID, where the reservation information indicates that the allocated second ASID is reserved.

The third processing unit 405 is configured to determine the first ASIDs in the ASID resource pool based on the reservation information of the allocated second ASID, and update the first ASIDs in the ASID generation iteration manner.

Optionally, the second processing unit 404 is configured to modify, from an unreserved state to a reserved state in a reservation bitmap, an identifier in an identifier bit corresponding to the allocated second ASID, where the reservation bitmap is used to record a reservation status of each ASID in the ASID resource pool.

Optionally, the third processing unit 405 is configured to determine, based on a global bitmap and the reserved state that is of the allocated second ASID and that is in the reservation bitmap, the first ASIDs on which generation iteration needs to be performed, where the global bitmap is used to record allocation statuses of ASIDs in the ASID resource pool, and update the first ASIDs in the ASID resource pool in the ASID generation iteration manner, and modify, from an allocated state to an unallocated state, identifiers that are in the global bitmap and that indicate statuses of the first ASIDs.

Optionally, the third processing unit 405 is further configured to, when the ASID resource pool further includes an unallocated ASID, and a quantity of second ASIDs allocated to processes run by the second processor core exceeds a waterline, allocate a second ASID from the unallocated ASID to a process run by the second processor core, and modify, from an unreserved state to a reserved state, an identifier bit that is of the second ASID allocated to the process run by the second processor core and that is in the reservation bitmap, where the waterline indicates a maximum quantity of second ASIDs reserved for the second processor core.

Optionally, the third processing unit 405 is further configured to, when the ASID resource pool does not include an unallocated ASID, and a quantity of second ASIDs allocated to processes run by the second processor core exceeds a waterline, update all the ASIDs in the ASID resource pool, modify, from an allocated state to an unallocated state, identifiers that indicate statuses of all the ASIDs and that are in the global bitmap, and modify identifiers in the reservation bitmap from a reserved state to an unreserved state, where the waterline indicates a maximum quantity of second ASIDs reserved for the second processor core.

Optionally, the third processing unit 405 is further configured to obtain a context ID of the process run by the second processor core, and if the context ID of the process includes a non-isolation identifier, modify the non-isolation identifier into an isolation identifier, and modify, from an unreserved state to a reserved state, an identifier that is of an ASID included in the context ID and that is in the reservation bitmap.

For the resource management apparatus described above, refer to corresponding content of the resource management method for understanding. Details are not described herein again.

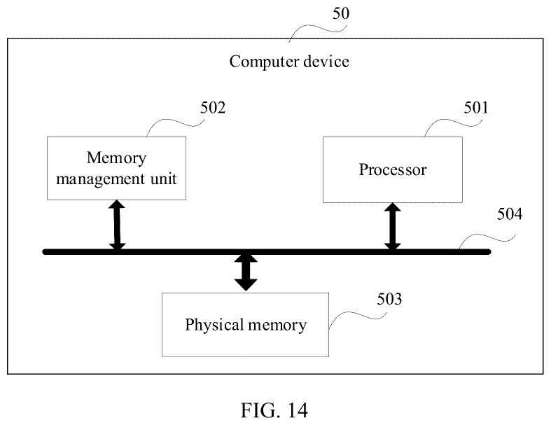

FIG. 14 is a schematic diagram of a possible logical structure of a computer device 50 according to an embodiment of this disclosure. The computer device 50 includes a processor 501, a memory management unit 502, a physical memory 503, and a bus 504. The processor 501, the memory management unit 502, and the physical memory 503 are connected to each other through the bus 504. The processor 501 may include a plurality of processor cores. The plurality of processor cores may be divided into a common core and an isolated core by using an isolation technology. The common core is configured to run a process of a common service, and the isolated core is configured to run a process of an isolated service.

In this embodiment of this disclosure, the processor 501 is configured to control and manage an action of the computer device 50. For example, the processor 501 is configured to perform the steps in the method embodiments in FIG. 1 to FIG. 12. The memory management unit 502 is configured to manage the physical memory. The physical memory 503 is configured to store program code and data of a dynamic library. Certainly, the computer device 50 provided in this embodiment of this disclosure further includes other components such as a communication interface and a magnetic disk, which are not shown one by one in FIG. 14.

The processor 501 may be a CPU, a general-purpose processor, a digital signal processor, an ASIC, an FPGA or another programmable logic device, a transistor logic device, a hardware component, or any combination thereof. The processor 501 may implement or execute various example logical blocks, modules, and circuits described with reference to content disclosed in this disclosure. Alternatively, the processor 501 may be a combination implementing a computing function, for example, a combination of one or more microprocessors, or a combination of a digital signal processor and a microprocessor. The bus 504 may be a Peripheral Component Interconnect (PCI) bus, an Extended Industry Standard Architecture (EISA) bus, or the like. Buses may be classified into an address bus, a data bus, a control bus, and the like. For ease of representation, only one bold line represents the bus in FIG. 14, but this does not mean that there is only one bus or only one type of bus.

In another embodiment of this disclosure, a computer-readable storage medium is further provided. The computer-readable storage medium stores computer-executable instructions. When a processor of a device executes the computer-executable instructions, the device performs the foregoing steps performed by the computer system in FIG. 1 to FIG. 10.

In another embodiment of this disclosure, a computer program product is further provided. The computer program product includes computer-executable instructions, and the computer-executable instructions are stored in a computer-readable storage medium. When a processor of a device executes the computer-executable instructions, the device performs the foregoing steps performed by the computer system in FIG. 1 to FIG. 12.

In another embodiment of this disclosure, a chip system is further provided. The chip system includes a processor. The processor is configured to support a resource management apparatus in implementing the steps performed by the computer system in FIG. 1 to FIG. 12. In a possible design, the chip system may further include a memory. The memory is configured to store program instructions and data that are necessary for a data writing apparatus. The chip system may include a chip, or may include a chip and another discrete component.

A person of ordinary skill in the art may be aware that, in combination with examples described in embodiments disclosed in this specification, units and algorithm steps may be implemented by electronic hardware or a combination of computer software and electronic hardware. Whether the functions are performed by hardware or software depends on particular applications and design constraints of the technical solution. A person skilled in the art may use different methods to implement the described functions for each particular application, but it should not be considered that the implementation goes beyond the scope of embodiments of this disclosure.

A person skilled in the art may clearly understand that, for the purpose of convenient and brief description, for a detailed working process of the foregoing system, apparatus, and unit, refer to a corresponding process in the foregoing method embodiments, and details are not described herein again.

In the several embodiments provided in embodiments of this disclosure, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may or may not be physically separate. Parts displayed as units may or may not be physical units, to be specific, may be located in one position, or may be distributed on a plurality of network units. Some or all of the units may be selected based on actual requirements to achieve the objectives of the solutions of embodiments.

In addition, functional units in embodiments of this disclosure may be integrated into one processing unit, or each of the units may exist alone physically, or two or more units are integrated into one unit.

When functions are implemented in the form of a software functional unit and sold or used as an independent product, the functions may be stored in a computer-readable storage medium. Based on such an understanding, the technical solutions of embodiments of this disclosure essentially, or the part contributing to the conventional technology, or some of the technical solutions may be implemented in a form of a software product. The computer software product is stored in a storage medium, and includes several instructions for instructing a computer device (which may be a personal computer, a server, or a network device, or the like) to perform all or some of the steps of the methods described in embodiments of this disclosure. The foregoing storage medium includes any medium that can store program code, such as a Universal Serial Bus (USB) flash drive, a removable hard disk, a read-only memory (ROM), a random-access memory (RAM), a magnetic disk, or an optical disc.

The foregoing descriptions are merely specific implementations of embodiments of this disclosure, but are not intended to limit the protection scope of embodiments of this disclosure.

1. A method implemented by a computer system, wherein the method comprises:
allocating, from a first address space identifier (ASID) resource pool, first ASIDs identifiers to first processes configured to be run by a first processor core of the computer system;
allocating a second ASID to a second process configured to be run by a second processor core of the computer system, wherein the second processor core is in an isolated environment; and
when the first ASIDs in the ASID resource pool are exhausted:
updating the first ASIDs in an ASID generation iteration manner to provide updated first ASIDs;
invalidating the first ASIDs; and
refreshing a translation lookaside buffer (TLB) in the first processor core.

2. The method of claim 1, wherein allocating the second ASID to the second process comprises allocating the second ASID from a second ASID resource pool to the second process, wherein the second ASID resource pool comprises third ASIDs, and wherein the second ASID is one of the third ASIDs.

3. The method of claim 1, further comprising:
further allocating the second ASID from the first ASID resource pool to the second process, wherein the first ASID resource pool further comprises at least one third ASID, and wherein the second ASID is a third ASID;
storing reservation information of the second ASID, wherein the reservation information indicates that the second ASID is reserved; and
determining the first ASIDs based on the reservation information.

4. The method of claim 3, further comprising modifying, a first identifier in an identifier bit corresponding to the second ASID from an unreserved state to a reserved state in a reservation bitmap, wherein the reservation bitmap records a reservation status of each of the at least one third ASID and the first ASIDs.

5. The method of claim 4, further comprising:
determining, the first ASIDs on which generation iteration are to be performed based on a global bitmap and the reserved state, wherein the global bitmap records allocation statuses of the first ASIDs and the at least one third ASID; and
modifying second identifiers that are in the global bitmap and that indicate first statuses of the first ASIDs from an allocated state to an unallocated state after updating the first ASIDs in the ASID generation iteration manner.

6. The method of claim 4, further comprising:
identifying that the first ASID resource pool comprises an unallocated ASID and a quantity of the at least one third ASID allocated to third processes configured to be run by the second processor core exceeds a waterline, wherein the waterline indicates a maximum quantity of the at least one third ASID reserved for the second processor core; and
in response to identifying that the first ASID resource pool further comprises the unallocated ASID and the quantity of the at least one third ASID exceeds the waterline:
allocating the unallocated ASID to a fourth process configured to be run by the second processor core; and
modifying a second identifier bit that is of the unallocated ASID and that is in the reservation bitmap from the unreserved state to the reserved state.

7. The method of claim 5, further comprising:
identifying that the first ASID resource pool does not include an unallocated ASID and a quantity of the at least one third ASID allocated to third processes configured to be run by the second processor core exceeds a waterline, wherein the waterline indicates a maximum quantity of the at least one third ASID reserved for the second processor core; and
in response to identifying that the first ASID resource pool does not include the unallocated ASID and the quantity of the at least one third ASID exceeds the waterline:
updating the first ASIDs and the at least one third ASID;
modifying third identifiers that indicate second statuses of the first ASIDs and the at least one third ASID and that are in the global bitmap from the allocated state to the unallocated state; and
modifying fourth identifiers in the reservation bitmap from the reserved state to the unreserved state.

8. The method of claim 4, further comprising:
obtaining a context identifier of the second process;
identifying that the context identifier comprises a non-isolation identifier; and
in response to identifying that the context identifier comprises the non-isolation identifier:
modifying the non-isolation identifier into an isolation identifier; and
modifying a second identifier that is of a fourth ASID comprised in the context identifier and that is in the reservation bitmap from the unreserved state to the reserved state.

9. A computing device comprising:
a computer-readable storage medium configured to store instructions; and
one or more processors comprising a first processor core and a second processor core, wherein the second processor core is in an isolated environment, coupled to the computer-readable storage medium, and configured to execute the instructions to cause the computing device to:
allocate, from a first address space identifier (ASID) resource pool, first ASIDs identifiers to first processes configured to be run by the first processor core;
allocate a second ASID to a second process configured to be run by the second processor core; and
when the first ASIDs in the ASID resource pool are exhausted:
update the first ASIDs in an ASID generation iteration manner to provide updated first ASIDs;
invalidate the first ASIDs; and
refresh a translation lookaside buffer (TLB) in the first processor core.

10. The computing device of claim 9, wherein the one or more processors are further configured to execute the instructions to cause the computing device to allocate the second ASID in a second ASID resource pool to the second process, wherein the second ASID resource pool comprises third ASIDs, and wherein the second ASID is one of the third ASIDs.

11. The computing device of claim 9, wherein the one or more processors are further configured to execute the instructions to cause the computing device to:
further allocate the second ASID comprised in the first ASID resource pool to the second process, wherein the first ASID resource pool further comprises at least one third ASID, and wherein the second ASID is a third ASID;
store reservation information of the second ASID, wherein the reservation information indicates that the second ASID is reserved; and
determine the first ASIDs based on the reservation information.

12. The computing device of claim 11, wherein the one or more processors are further configured to execute the instructions to cause the computing device to modify a first identifier in an identifier bit corresponding to the second ASID from an unreserved state to a reserved state in a reservation bitmap, and wherein the reservation bitmap records a reservation status of each of the at least one third ASID and the first ASIDs.

13. The computing device of claim 12, wherein the one or more processors are further configured to execute the instructions to cause the computing device to:
determine the first ASIDs on which generation iteration are to be performed based on a global bitmap and the reserved state, wherein the global bitmap records allocation statuses of the first ASIDs and the at least one third ASID; and
modify second identifiers that are in the global bitmap and that indicate first statuses of the first ASIDs from an allocated state to an unallocated state after updating the first ASIDs in the ASID generation iteration manner.

14. The computing device of claim 12, wherein the one or more processors are further configured to execute the instructions to cause the computing device to:
identify that the first ASID resource pool further comprises an unallocated ASID and a quantity of the at least one third ASID allocated to third processes configured to be run by the second processor core exceeds a waterline, wherein the waterline indicates a maximum quantity of the at least one third ASID reserved for the second processor core; and
in response to identifying that the first ASID resource pool further comprises the unallocated ASID and the quantity of the at least one third ASID exceeds the waterline:
allocate the unallocated ASID to a fourth process configured to be run by the second processor core; and
modify a second identifier bit that is of the unallocated ASID and that is in the reservation bitmap from the unreserved state to the reserved state.

15. The computing device of claim 13, wherein the one or more processors are further configured to execute the instructions to cause the computing device to:
identify that the first ASID resource pool does not include an unallocated ASID and a quantity of the at least one third ASID allocated to third processes configured to be run by the second processor core exceeds a waterline, wherein the waterline indicates a maximum quantity of the at least one third ASID reserved for the second processor core; and
in response to identifying that the first ASID resource pool does not include the unallocated ASID and the quantity of the at least one third ASID exceeds the waterline:
update the first ASIDs and the at least one third ASID;
modify third identifiers that indicate second statuses of the first ASIDs and the at least one third ASID and that are in the global bitmap from the allocated state to the unallocated state; and
modify fourth identifiers in the reservation bitmap from the reserved state to the unreserved state.

16. The computing device of claim 12, wherein the one or more processors are further configured to execute the instructions to cause the computing device to:
obtain a context identifier of the second process;
identify that the context identifier comprises a non-isolation identifier; and
in response to identifying that the context identifier comprises the non-isolation identifier:
modify the non-isolation identifier into an isolation identifier; and
modify a second identifier that is of a fourth ASID comprised in the context identifier and that is in the reservation bitmap from the unreserved state to the reserved state.

17. A chip system, comprising:
one or more processors comprising a first processor core and a second processor core that is in an isolated environment, wherein the one or more processors are configured to:
allocate, from a first address space identifier (ASID) resource pool, first ASIDs identifiers to first processes configured to be run by the first processor core;
allocate a second ASID to a second process configured to be run by the second processor core; and
when the first ASIDs in the ASID resource pool are exhausted:
update the first ASIDs in an ASID generation iteration manner to provide updated first ASIDs;
invalidate the first ASIDs; and
refresh a translation lookaside buffer (TLB) in the first processor core.

18. The chip system of claim 17, wherein the one or more processors are further configured to allocate the second ASID comprised in a second ASID resource pool to the second process, wherein the second ASID resource pool comprises third ASIDs, and wherein the second ASID is one of the third ASIDs.

19. A computer program product comprising computer-executable instructions that are stored on a non-transitory computer-readable storage medium and that, when executed by one or more processors, cause a computing device to:
allocate, from a first address space identifier (ASID) resource pool, first ASIDs identifiers to first processes configured to be run by a first processor core of the one or more processors;
allocate a second ASID to a second process configured to be run by a second processor core of the one or more processors, wherein the second processor core is in an isolated environment; and
when the first ASIDs in the ASID resource pool are exhausted:
update the first ASIDs in an ASID generation iteration manner to provide updated first ASIDs;
invalidate the first ASIDs; and
refresh a translation lookaside buffer (TLB) in the first processor core.

20. The computer program product of claim 19, wherein the computer-executable instructions further cause the computing device to allocate the second ASID in a second ASID resource pool to the second process, wherein the second ASID resource pool comprises third ASIDs, and wherein the second ASID is one of the third ASIDs.
